(19) United States
(12) Patent Application Publication
(10) Pub. No.: US 2024/0175706 A1
(43) Pub. Date: May 30, 2024

(54) SYSTEM AND METHOD FOR GENERATING A SEMANTIC MAP FOR A ROAD

(71) Applicant: Woven by Toyota, Inc., Tokyo (JP)

(72) Inventor: Alexander Christoph Schaefer, Fremont, CA (US)

(73) Assignee: Woven by Toyota, Inc., (omitted)

(21) Appl. No.: 18/072,203

(22) Filed: Nov. 30, 2022

(51) Int. Cl. G01C 21/00; G06V 20/56

(52) U.S. Cl. CPC G01C 21/3822; G06V 20/588; B60W 40/072

(57) ABSTRACT

Systems, methods, and other embodiments described herein relate to generating a semantic map for a road segment. In one embodiment, a method includes receiving sensor data related to a road segment. The sensor data includes trace points and key points associated with the trace points. The trace points are related to positions of a vehicle in the road segment and the key points are related to lane boundaries. The method includes generating hypothetical lane configurations, generating scores based on how accurately the key points match the hypothetical lane configurations, and selecting one hypothetical lane configuration from the hypothetical lane configurations based on a score among the scores. The score indicating most accurate match. The method includes determining characteristics of the road segment based on the one hypothetical lane configuration.

### TECHNICAL FIELD

The subject matter described herein relates, in general, to systems and methods for generating a semantic map for a road.

### BACKGROUND

Semantic road maps include information about a road, such as the number of lanes, the lane widths, and the lane boundaries of the road. Semantic road maps may facilitate autonomous vehicle operation. However, semantic road maps are typically generated using methods that are both labor and resource intensive.

### SUMMARY

In one embodiment, a system for generating a semantic map for a road segment is disclosed. The system includes a processor and a memory in communication with the processor. The memory stores machine-readable instructions that, when executed by the processor, cause the processor to receive sensor data related to a road segment. The sensor data includes a plurality of trace points and a plurality of key points associated with the plurality of trace points. The plurality of trace points is related to positions of a vehicle in the road segment and the plurality of key points is related to lane boundaries. The machine-readable instructions further include machine-readable instructions that, when executed by the processor, cause the processor to generate a plurality of hypothetical lane configurations, generate a plurality of scores based on how accurately the plurality of key points matches the plurality of hypothetical lane configurations, and select one hypothetical lane configuration from the plurality of hypothetical lane configurations based on one score of the plurality of scores, where the one score indicates most accurate match. The machine-readable instructions further include machine-readable instructions that, when executed by the processor, cause the processor to determine characteristics of the road segment based on the one hypothetical lane configuration.

In another embodiment, a method for generating a semantic map for a road segment is disclosed. The method includes receiving sensor data related to a road segment. The sensor data includes a plurality of trace points and a plurality of key points associated with the plurality of trace points. The plurality of trace points is related to positions of a vehicle in the road segment and the plurality of key points is related to lane boundaries. The method further includes generating a plurality of hypothetical lane configurations, generating a plurality of scores based on how accurately the plurality of key points matches the plurality of hypothetical lane configurations, and selecting one hypothetical lane configuration from the plurality of hypothetical lane configurations based on one score of the plurality of scores, where the one score indicates most accurate match. The method includes determining characteristics of the road segment based on the one hypothetical lane configuration.

In another embodiment, a non-transitory computer-readable medium for generating a semantic map for a road segment is disclosed. The non-transitory computer-readable medium includes instructions that, when executed by a processor, cause the processor to perform one or more functions, is disclosed. The instructions include instructions to receive sensor data related to a road segment. The sensor data includes a plurality of trace points and a plurality of key points associated with the plurality of trace points. The plurality of trace points is related to positions of a vehicle in the road segment and the plurality of key points is related to lane boundaries. The instructions include instructions to generate a plurality of hypothetical lane configurations, generate a plurality of scores based on how accurately the plurality of key points matches the plurality of hypothetical lane configurations, and select one hypothetical lane configuration from the plurality of hypothetical lane configurations based on one score of the plurality of scores, where the one score indicates most accurate match. The instructions include instructions to determine characteristics of the road segment based on the one hypothetical lane configuration.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A-1D illustrate an example of a semantic map generating system.

FIG. 2 illustrates one embodiment of the semantic map generating system.

FIG. 3 is a flowchart illustrating one embodiment of a method associated with generating a semantic map at a road level.

FIG. 4 is a flowchart illustrating one embodiment of a method associated with generating a semantic map at a road segment level.

### DETAILED DESCRIPTION

Systems, methods, and other embodiments associated with systems and methods for generating a semantic map for a road are disclosed. A semantic map of a road includes the number of lanes along the road, the width of the lanes, the positions of lane markings, lane boundaries, and/or lane edges. The information included in the semantic map may facilitate autonomous vehicle operation.

Current methods of generating a semantic map for a road include image processing visual sensor data. However, these methods can be labor-intensive, time-consuming, expensive, and require extensive storage and computational resources as the prior art discloses detecting images, storing the images, and manually identifying and labelling objects and signage detected in the images. These methods also have a high level of inaccuracies.

Accordingly, systems, methods, and other embodiments associated with generating a semantic map for a road are disclosed. The system generates a semantic map of the road in a given area based on ground-truth vehicle trace points and key points which are detected by the vehicle sensors. This system generates the corresponding semantic representation for a road with certain characteristics, such as a road that is between but not including intersections.

As an example, the system receives sensor data from vehicle sensors (such as TSS3 sensors) as vehicles travel along the road. The vehicle sensors such as Global Positioning Systems (GPS), inertial measurement unit (IMU), and accelerometers can include information about the location of the vehicle, known as trace points. Additionally, vehicle sensors such as cameras, LIDAR sensors, and radar sensors can include information about the environment, such as lane markings, known as key points. Key points include left key points, which identify lane markings detected to the left of the vehicle based on the direction of travel of the vehicle. Key points also include right key points, which identify lane markings detected to the right of the vehicle based on the direction of travel of the vehicle.

The system generates a semantic map for the road by dividing the road into road segments. The system generates a set of hypothetic lane configurations based on all possible configurations of lane numbers, lane orientation, and discretized lane widths within a predefined set of limits. As an example, the possible configurations may include (3,3) representing a two 3-meter wide lane road or (2,3,5) representing a three-lane road with lanes 2 meters, 3 meters, and 5 meters wide.

The system overlays the hypothetical lane configurations on the road segment, determines which lane the trace points fall into based on the hypothetical lane configurations, and then fits a curve or line to the left key points associated with the trace points that fall within the same lane. Similarly, the system fits another curve or line to the right key points associated with the trace points that fall within the same lane. The system determines the best fit by determining the lateral variance between the curve and the key points. The smaller the variance, the lower the score, the better the fit of the curve to the key points. The system selects the lane number-lane width-lane orientation configuration matching the lowest score as the lane number-lane width-lane orientation configuration for the road segment. Upon generating the semantic maps for the road segments, the system combines the semantic maps into a single semantic map representing the road.

The embodiments disclosed herein present various advantages over conventional technologies that generate a semantic map for a road based on image processing. First, the embodiments can provide a more accurate prediction of the characteristics of the lanes, such as number of lanes, lane width, positions of lane markings, lane boundaries, and lane edges. Second, the embodiments are less resource-intensive than the prior art. Third, the embodiments simplify the process of generating a semantic map for the road.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

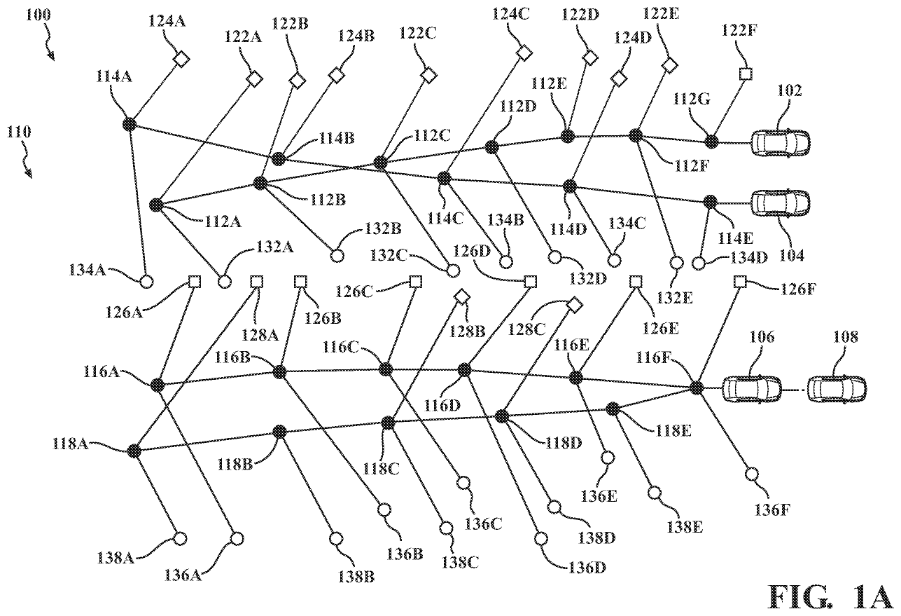

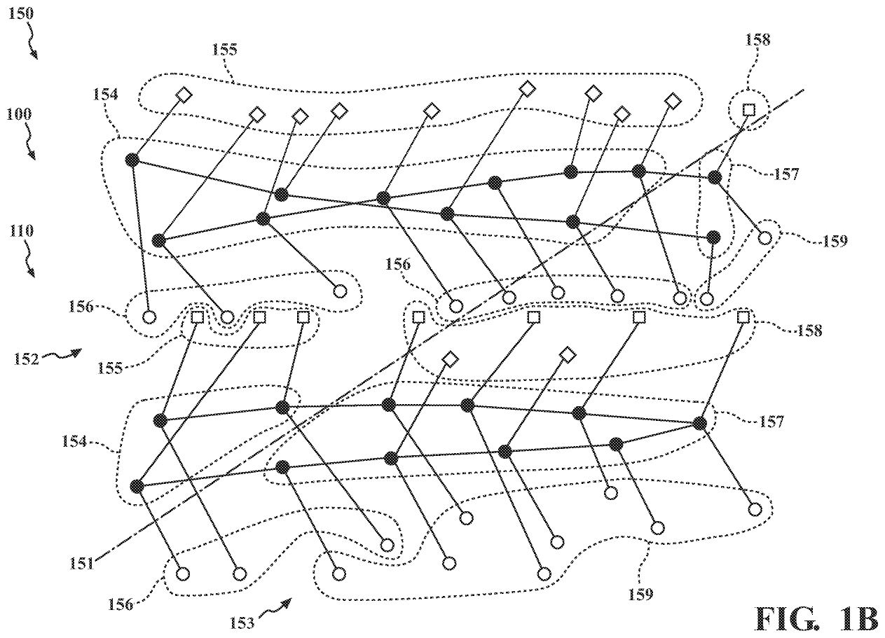

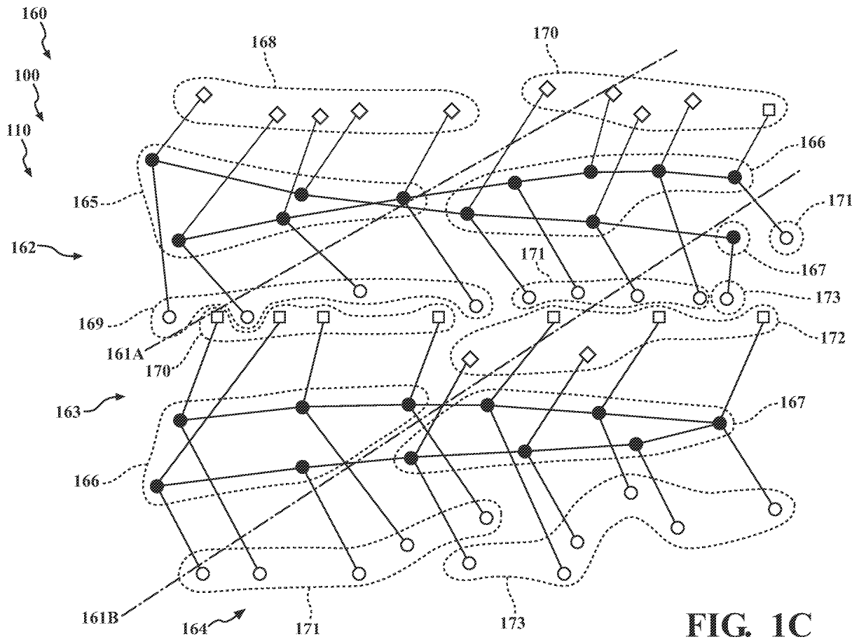

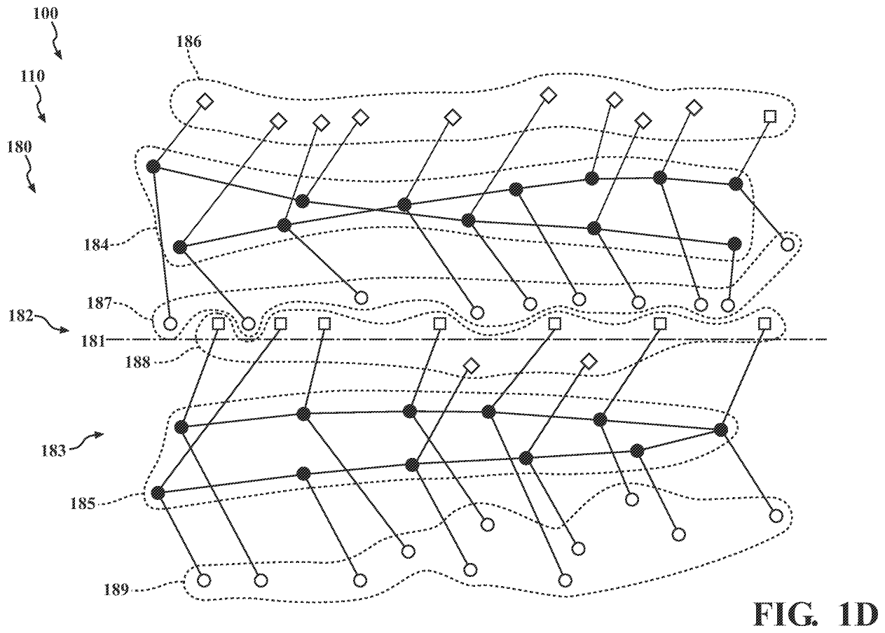

FIGS. 1A-1D illustrate an example of a semantic map generating system 100. The semantic map generating system 100 receives sensor data from any suitable sensors. As an example, the semantic map generating system 100 may receive sensor data from mobile sensors such as vehicle sensors and/or stationary sensors such as roadside sensors or infrastructure sensors. As an example, vehicles 102, 104, 106, 108 are travelling in the same direction and generating sensor data.

The sensor data includes trace points 112A, 112B, 112C, 112D, 112E, 112F, 112G (collectively known as 112), which identify the positions of the vehicle 102 as the vehicle 102 travels across the road segment. The sensor data includes left key points 122A, 122B, 122C, 122D, 122E (collectively known as 122), which identify a left boundary of a lane that the vehicle 102 is traveling on. The sensor data includes right key points 132A, 132B, 132C, 132D, 132E (collectively known as 132), which identify a right boundary of the lane that the vehicle 102 is traveling on. As an example, when the vehicle 102 is at the trace point 112A, sensors on the vehicle 102 detect a left lane marking at the left key point 122A and a right lane marking at the right key point 132A.

The sensor data includes trace points 114A, 114B, 114C, 114D, 114E (collectively known as 114), which identify the positions of the vehicle 104 as the vehicle 104 travels across the road segment. The sensor data includes left key points 124A, 124B, 124C, 124D (collectively known as 124), which identify a left boundary of a lane that the vehicle 104 is traveling on. The sensor data includes right key points 134A, 134B, 134C, 134D (collectively known as 134), which identify a right boundary of the lane that the vehicle 104 is traveling on.

The sensor data includes trace points 116A, 116B, 116C, 116D, 116E, 116F (collectively known as 116), which identify the positions of the vehicle 106 as the vehicle 106 travels across the road segment. The sensor data includes left key points 126A, 126B, 126C, 126D, 126E, 126F (collectively known as 126), which identify a left boundary of a lane that the vehicle 106 is traveling on. The sensor data includes right key points 136A, 136B, 136C, 136D, 136E, 136F (collectively known as 136), which identify a right boundary of the lane that the vehicle 106 is traveling on.

The sensor data includes trace points 118A, 118B, 118C, 118D, 118E (collectively known as 118) which identify the positions of the vehicle 108 as the vehicle 108 travels across the road segment. The sensor data includes left key points 128A, 128B, 128C (collectively known as 128), which identify a left boundary of a lane that the vehicle 108 is traveling on. The sensor data includes right key points 138A, 138B, 138C, 138D, 138E (collectively known as 138), which identify a right boundary of the lane that the vehicle 108 is traveling on.

The semantic map generating system 100 may receive sensor data related to a portion of a road. As an example, the portion of the road may extend from a first end of the road at a first intersection to a second end of the road at a second intersection. As such, the road may be of any suitable length without any intersections. The semantic map generating system 100 may aggregate the sensor data for the road into a common reference system such that the relationship between the vehicles 102, 104, 106, 108, the trace points 112, 114, 116, 118, and the key points 122, 132, 124, 134, 126, 136, 128, 138 is consistent. As an example, the common reference system may be based on the Global Positioning System (GPS).

The semantic map generating system 100 may divide the road and the sensor data into multiple road segments 110 and sensor data associated with the road segments. The size of the road segment may be based on a curve of the road, and/or the number of trace points 112, 114, 116, 118 and key points 122, 132, 124, 134, 126, 136, 128, 138 within a road segment. In other words, the semantic map generating system 100 may divide the road into road segments so as to minimize edges of the road segment being curved. The semantic map generating system may divide the road into road segments 110 that are large enough to include multiple trace points 112, 114, 116, 118 and key points 122, 132, 124, 134, 126, 136, 128, 138 such that the amount of trace points 112, 114, 116, 118 and key points 122, 132, 124, 134, 126, 136, 128, 138 are sufficient for determining and generating an accurate semantic map and small enough to keep noise to a minimum. The semantic map generating system 100 may divide the road segments to minimize merging and/or splitting of lanes from occurring in the road segments. As an example, the semantic map generating system 100 may divide the road segment 110 at the point of the merge or the point of the split.

The semantic map generating system 100 generates a plurality of hypothetical lane configurations 150, 160, 180 to represent different lane combinations (e.g., number of lanes, lane widths, lane orientation, lane shape).

As an example and as shown in FIG. 1B, the hypothetical lane configuration 150 includes a single line 151 traversing the trace points 112, 114, 116, 118 and the key points 122, 132, 124, 134, 126, 136, 128, 138. In this hypothetical lane configuration 150, the semantic map generating system 100 hypothesizes that the road segment has a left lane 152 and a right lane 153 with the single line 151 being the center lane boundary line.

The semantic map generating system 100 identifies that a first set of trace points (grouped and labeled as 154) are in the hypothesized left lane 152 and a second set of trace points (grouped and labeled as 157) are in the hypothesized right lane 153. The hypothesized left lane trace points 154 are associated with a first set of left key points (grouped and labeled as 155) that identify the left boundary of the left lane 152 and a first set of right key points (grouped and labeled as 156) that identify the right boundary of the left lane 152.

The hypothesized right lane trace points 157 are associated with a second set of left key points (grouped and labeled as 158) that identify the left boundary of the right lane 153 and a second set of right key points (grouped and labeled as 159) that identify the right boundary of the right lane 153.

The semantic map generating system 100 fits a curve indicating the left boundary of the left lane 152 to the first set of left key points 155. The semantic map generating system 100 fits a curve indicating the right boundary of the left lane 152 to the first set of right key points 156. The semantic map generating system 100 fits a curve indicating the left boundary of the right lane 153 to the second set of left key points 158. The semantic map generating system 100 fits a curve indicating the right boundary of the right lane 153 to the second set of right key points 159. Additionally, the semantic map generating system 100 may fit a curve indicating the center lane boundary line to the first set of right key points 156 and the second set of left key points 158.

The semantic map generating system 100 assigns a score to the curves based on how closely the associated curves fit the key points 155, 156, 158, 159. The semantic map generating system 100 may use any suitable method to fit the curves to the key points 155, 156, 158, 159 and determine a fit score. As an example, the semantic map generating system 100 may use a least squares method.

As another example and as shown in FIG. 1C, the hypothetical lane configuration 160 includes two lines 161A, 161B traversing the trace points 112, 114, 116, 118 and the key points 122, 132, 124, 134, 126, 136, 128, 138. In this hypothetical lane configuration 160, the semantic map generating system 100 hypothesizes that the road segment has a left lane 162, a middle lane 163, and a right lane 164 with a first line 161A being a first lane boundary line between the left lane 162 and the middle lane 163, and a second line 161B being a second lane boundary line between the middle lane 163 and the right lane 164.

The semantic map generating system 100 identifies that a first set of trace points (grouped and labeled as 165) are in the hypothesized left lane 162, a second set of trace points (grouped and labeled as 166) are in the hypothesized middle lane 163, and a third set of trace points (grouped and labeled as 167) are in the hypothesized right lane 164.

The hypothesized left lane trace points 165 are associated with a first set of left key points (grouped and labeled as 168) that identify the left boundary of the left lane 162 and a first set of right key points (grouped and labeled as 169) that identify the right boundary of the left lane 162.

The hypothesized middle lane trace points 166 are associated with a second set of left key points (grouped and labeled as 170) that identify the left boundary of the middle lane 163 and a second set of right key points (grouped and labeled as 171) that identify the right boundary of the middle lane 163.

The hypothesized right lane trace points 167 are associated with a third set of left key points (grouped and labeled as 172) that identify the left boundary of the right lane 164 and a third set of right key points (grouped and labeled as 173) that identify the right boundary of the right lane 164.

The semantic map generating system 100 fits a curve indicating the left boundary of the left lane 162 to the first set of left key points 168. The semantic map generating system 100 fits a curve indicating the right boundary of the left lane 162 to the first set of right key points 169.

The semantic map generating system 100 fits a curve indicating the left boundary of the middle lane 163 to the second set of left key points 170. The semantic map generating system 100 fits a curve indicating the right boundary of the middle lane 163 to the second set of right key points 171.

The semantic map generating system 100 fits a curve indicating the left boundary of the right lane 164 to the third set of left key points 172. The semantic map generating system 100 fits a curve indicating the right boundary of the right lane 164 to the second set of right key points 173.

Additionally, the semantic map generating system 100 fits a curve indicating the first lane boundary line to the first set of right key points and the second set of left key points. Further, the semantic map generating system 100 fits a curve indicating the second lane boundary line to the second set of right key points and the third set of left key points. The semantic map generating system 100 assigns a score to the curves based on how closely the associated curves fit the key points 168, 169, 170, 171, 172, 173.

As an example and as shown in FIG. 1D, the hypothetical lane configuration 180 includes a single line 181 traversing the trace points 112, 114, 116, 118 and the key points 122, 132, 124, 134, 126, 136, 128, 138. In this hypothetical lane configuration 180, the semantic map generating system 100 hypothesizes that the road segment has a left lane 182 and a right lane 183 with the single line 181 being the center lane boundary line.

The semantic map generating system 100 identifies that a first set of trace points (grouped and labeled as 184) are in the hypothesized left lane 182 and a second set of trace points (grouped and labeled as 185) are in the hypothesized right lane 183. The hypothesized left lane trace points 184 are associated with a first set of left key points (grouped and labeled as 186) that identify the left boundary of the left lane 182 and a first set of right key points (grouped and labeled as 187) that identify the right boundary of the left lane 182.

The hypothesized right lane trace points 185 are associated with a second set of left key points (grouped and labeled as 188) that identify the left boundary of the right lane 183 and a second set of right key points (grouped and labeled as 189) that identify the right boundary of the right lane 183.

The semantic map generating system 100 fits a curve indicating the left boundary of the left lane 182 to the first set of left key points 186. The semantic map generating system 100 fits to a curve indicating the right boundary of the left lane 182 to the first set of right key points 187. The semantic map generating system 100 fits a curve indicating the left boundary of the right lane 183 to the second set of left key points 188. The semantic map generating system 100 fits a curve indicating the right boundary of the right lane 183 to the second set of right key points 189. Additionally, the semantic map generating system 100 may fit a curve indicating the center lane boundary line to the first set of right key points 187 and the second set of left key points 188.

The semantic map generating system 100 assigns a score to the curves based on how closely the associated curves fit to the key points 186, 187, 188, 189. The semantic map generating system may use any suitable method to fit the curves to the key points 186, 187, 188, 189 and determine a fit score.

The semantic map generating system 100 compares the scores for the various configurations 150, 160, 180. In this example, the semantic map generating system identifies and selects the configuration 180 as having the lowest score and as such, providing the best fit. The semantic map generating system 100 arranges the lane boundaries on the road segment 110 based on the selected configuration 180. The semantic map generating system 100 then re-constitutes the road segments 110 with the lane boundary information back into the road.

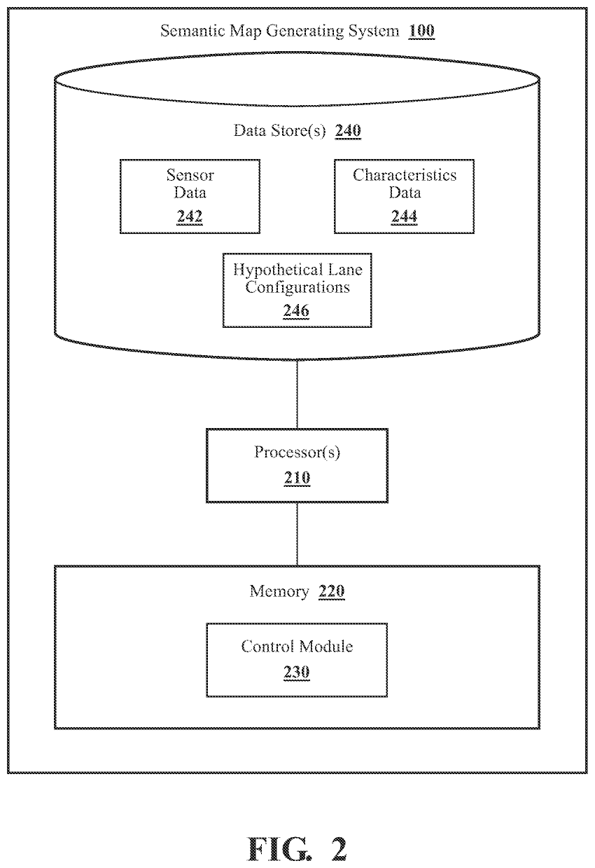

With reference to FIG. 2, one embodiment of the semantic map generating system 100 of FIG. 1 is further illustrated. The semantic map generating system 100 is shown as including a processor 210. Accordingly, the processor 210 may be a part of the semantic map generating system 100, or the semantic map generating system 100 may access the processor 210 through a data bus or another communication path. In one or more embodiments, the processor 210 is an application-specific integrated circuit (ASIC) that is configured to implement functions associated with a control module 230. In general, the processor 210 is an electronic processor, such as a microprocessor, which is capable of performing various functions as described herein.

In one embodiment, the semantic map generating system 100 includes a memory 220 that stores the control module 230 and/or other modules that may function in support of generating a semantic map of a road. The memory 220 is a random-access memory (RAM), read-only memory (ROM), a hard disk drive, a flash memory, or another suitable memory for storing the control module 230. The control module 230 is, for example, machine-readable instructions that, when executed by the processor 210, cause the processor 210 to perform the various functions disclosed herein. In further arrangements, the control module 230 is a logic, integrated circuit, or another device for performing the noted functions that includes the instructions integrated therein.

Furthermore, in one embodiment, the semantic map generating system 100 includes a data store 240. The data store 240 is, in one arrangement, an electronic data structure stored in the memory 220 or another data store, and that is configured with routines that can be executed by the processor 210 for analyzing stored data, providing stored data, organizing stored data, and so on. Thus, in one embodiment, the data store 240 stores data used by the control module 230 in executing various functions.

For example, as depicted in FIG. 2, the data store 240 includes the sensor data 242, characteristics data 244, and a set of hypothetical lane configuration data 246, along with, for example, other information that is used and/or produced by the control module 230. The sensor data 242 includes information about the positions 112, 114, 116, 118 of the vehicles 102, 104, 106, 108 and the positions 122, 132, 124, 134, 126, 136, 128, 138 of detected lane markings. Vehicle sensors and/or any other suitable sensors may detect the positions 112, 114, 116, 118 of the vehicles 102, 104, 106, 108 and the positions 122, 132, 124, 132, 126, 136, 128, 138 of detected lane markings.

The characteristics data 244 may include characteristics of the road, such as the location of the road, width of the road, length of the road, type of road (e.g., a country road, a highway, a paved road, an unpaved road), time of day, and weather. The semantic map generating system 100 may receive characteristics of the road from various sensors, surrounding infrastructure, or external databases. The characteristics data 244 may include historical data such as lane number-lane width configurations associated with the road and/or the road segment 110. The characteristics data 244 may further include lane number-lane width configurations associated with other road segments on the road.

The set of hypothetical lane configurations 150, 160, 180 includes hypothetical lane configurations based on varying lane numbers and lane widths for the road segment 110. As an example, the hypothetical lane configurations 150, 160, 180 could be based on a one 6-meter lane configuration, a two 4-meter lane configuration, a three 3-meter lane configuration, and/or a four (two 5-meter lane, one 4-meter lane, one 3-meter lane) lane configuration. The semantic map generating system 100 may generate the hypothetical lane configurations 150, 160, 180 based on the characteristics data 244. As such, the semantic map generating system 100 may initially generate a large set of hypothetical lane configurations 150, 160, 180 without considering any factors such as location of the road, etc. The semantic map generating system 100 may then include such considerations to customize and reduce the number of hypothetical lane configurations 150, 160, 180 in the set of hypothetical lane configurations 150, 160, 180. As an example, the semantic map generating system 100 may customize and reduce the number of hypothetical lane configurations 150, 160, 180 based on historical information for the road segment 110. In such an example, the semantic map generating system 100 may consider previous lane number-lane width configurations associated with the road segment 110. The semantic map generating system 100 may further customize the set of hypothetical lane configurations 150, 160, 180 based on lane number-lane width configurations of neighboring road segments.

While the semantic map generating system 100 is illustrated as including the various data elements, it should be appreciated that one or more of the illustrated data elements may not be included within the data store 240 in various implementations and may be included in a data store that is external to the semantic map generating system 100. In any case, the semantic map generating system 100 stores various data elements in the data store 240 to support functions of the control module 230.

In one embodiment, the control module 230 includes instructions that, when executed by the processor(s) 210, cause the processor(s) 210 to receive sensor data 242 related to a road segment 110. The sensor data includes a plurality of trace points and a plurality of key points associated with the plurality of trace points. The trace points are related to positions of a vehicle in the road segment, and the key points are related to lane boundaries as detected by the vehicle sensors and/or other sensors.

In one or more arrangements, the control module 230 receives sensor data 242 related to a portion of a road. Additionally and/or alternatively, the control module 230 may receive the sensor data 242 related to a road segment 110 which is a portion of the road. The sensor data 242 may be from vehicle sensors or any other suitable sensors. The control module 230 may receive the sensor data 242 from the vehicle sensors and/or the other sensors. As previously mentioned, the sensor data 242 may include the position 112, 114, 116, 118 of the vehicles 102, 104, 106, 108 and the position 122, 132, 124, 134, 126, 136, 128, 138 of detected lane markings. In other words, the sensor data 242 may include the position 112, 114, 116, 118 of vehicle 102, 104, 106, 108 (also known as trace points) and the position 122, 132, 124, 134, 126, 136, 128, 138 of lane markings (also known as key points) detected by the vehicle sensor(s) while the vehicles were in the positions 112, 114, 116, 118.

In one or more arrangements, the key points may include one or more key points. The key points may include at least a left key point and a right key point. The left key point is associated with a left lane boundary, that is a lane boundary that is left relative to the direction of travel of the vehicle. The right key point is associated a right lane boundary, which is a lane boundary that is right relative to the direction of travel of the vehicle sensor.

In one or more arrangements, the control module 230 divides the road into multiple road segments including the road segment 110. The control module 230 may determine the size of the road segments based on the curve of the road and/or the number of trace points 112, 114, 116, 118 and key points 122, 132, 124, 134, 126, 136, 128, 138 in the road segments 110. As an example, the control module 230 may divide the road into road segments 110 such that the edges of road segments 110 within a curved portion of the road are relatively straight. As another example, the control module 230 may divide the road into road segments 110 based on the amount of trace points 112, 114, 116, 118 and key points 122, 132, 124, 134, 126, 136, 128, 138. The control module 230 may determine a suitable number of trace points 112, 114, 116, 118 and key points 122, 132, 124, 134, 126, 136, 128, 138 to maximize accuracy and minimize noise using any suitable method or process. The control module 230 may divide the road into road segments 110 that may be of equal sizes or may be of unequal sizes.

In one embodiment, the control module 230 includes instructions that, when executed by the processor(s) 210, cause the processor(s) 210 to generate a plurality of hypothetical lane configurations 150, 160, 180, generate a plurality of scores based on how accurately the key points match the hypothetical lane configurations 150, 160, 180, and select one hypothetical lane configuration from the hypothetical lane configurations 150, 160, 180 based on a score associated with the selected hypothetical lane configuration 180 where the score is the lowest score, indicating the best match.

In one or more arrangements, the control module 230 generates the hypothetical lane configurations 150, 160, 180 based on the potential characteristics of the road segment 110. The potential characteristics of the road segment 110 include the number of lanes in the road segment 110, the width of the lanes in the road segment 110, the position and/or orientation of lane marking(s) on the road segment 110, and/or the position of boundaries (or edges) of the road segment 110. As previously mentioned, the hypothetical lane configurations 150, 160, 180 may include various lane numbers, lane widths, and lane orientation configurations. The control module 230 may generate the hypothetical lane configurations 150, 160, 180 using any suitable method or process such as a permutation or combination generation process.

In one or more arrangements, the control module 230 may generate the hypothetical lane configurations 150, 160, 180 based on historical information. As previously mentioned, historical information may be lane number-lane width-lane orientation configurations previously associated with the road segment 110. As an example, in a case where the road segment 110 had been recorded in a mapping database as having two lanes, the control module 230 may begin by limiting the hypothetical lane configurations to two lanes of varying lane widths and orientations, and may expand the hypothetical lane configurations 150, 160, 180 to include less than two lanes and/or more than two lanes if the control module 230 is unable to secure a match with the initial hypothetical lane configurations 150, 160, 180 limited to two lanes.

In one or more arrangements, the control module 230 may generate the hypothetical lane configurations 150, 160, 180 based on characteristics of the environment of the road segment. As previously mentioned, the characteristics of the environment of the road and/or the road segment may be the width of the road, the length of the road, the orientation of the road, the type of road, and/or the location of the road. As an example, the control module 230 may receive information from a local database indicating that roads in the related location typically have three lanes. As such, the control module 230 may limit the hypothetical lane configurations 150, 160, 180 to three lanes of varying widths and orientations.

In one or more arrangements, the control module 230 may generate the hypothetical lane configurations 150, 160, 180 based on characteristics of a neighboring road segment. A neighboring road segment may be adjacent to or in close proximity to the road segment 110. As an example, in a case where the control module 230 has resolved the lane number-lane width-lane orientation configuration of a neighboring segment, the control module 230 may generate the hypothetical lane configurations 150, 160, 180 based on the resolved lane number and lane widths, and/or lane orientation. In such an example, the control module 230 may limit the hypothetical lane configurations 150, 160, 180 to one lane less than the resolved lane number and to one lane more than the resolved lane number. Further, as an example, the control module 230 may limit the hypothetical lane configurations 150, 160, 180 to 1 meter less than the resolved lane widths and to 2 meters more than the resolved lane widths.

The control module 230 may generate the hypothetical lane configurations 150, 160, 180 without any lane number, lane width, or lane orientation restrictions. Alternatively, the control module 230 may consider any suitable restrictions such as data storage units or computational capability when generating the hypothetical lane configurations 150, 160, 180.

In one embodiment, the control module 230 includes instructions that, when executed by the processor(s) 210, cause the processor(s) 210 to determine a plurality of scores based on how accurately the key points match the hypothetical lane configurations 150, 160, 180. As an example, the control module 230 may identify the hypothesized lanes based on the hypothetical lane configuration, as previously explained. The control module 230 may compute a score that expresses how accurately the key points match the hypothetical lane configuration. As previously mentioned, the key points may include left key points and right key points. The left key points identify the lane boundary line to the left of the vehicle and the right key points identify the lane boundary line to the right of the vehicle. As such, the control module 230 may fit a first curve or line to the left key points associated with trace points within the hypothesized lane. Similarly, the control module 230 may fit a second curve or line to the right key points associated with trace points within the hypothesized lane. The control module 230 may use any suitable method such as a least squares method to fit the curve to the key points. The control module 230 may then determine how accurate the fit is by measuring the variance between the left key points and the first curve and further measuring the variance between the right key points and the second curve. The control module 230 may determine a score for the hypothetical lane configuration based on the measured variances. The lower the variance between the key points and the curves, the more accurate the curves are and the lower the score.

Upon applying multiple hypothetical lane configurations 150, 160, 180 to the trace points 112, 114, 116, 118 and key points 122, 132, 124, 134, 126, 136, 128, 138, the control module 230 produces a variety of scores based on how accurately the key points match the hypothetical lane configurations 150, 160, 180.

In one embodiment, the control module 230 includes instructions that, when executed by the processor(s) 210, cause the processor(s) 210 to select a hypothetical lane configuration from the multiple hypothetical lane configurations 150, 160, 180 based on a score that indicates the most accurate match among the variety of scores. As an example, the score indicating the most accurate match between the key points and the selected hypothetical lane configuration may be the lowest score (or lowest variance). As such, the lowest score may indicate that the associated hypothetical lane configuration 180 best matches the key points. Additionally, the control module 230 may compare the lowest score to a threshold value and in a case where the lowest score is within the threshold value, the control module 230 may select the hypothetical lane configuration 180 associated with the lowest score. In a case where the lowest score exceeds the threshold, the control module 230 may expand the hypothetical lane configurations 150, 160, 180 with alternative lane number-lane width-lane orientation configurations.

In one embodiment, the control module 230 includes instructions that, when executed by the processor(s) 210, cause the processor(s) 210 to determine characteristics of the road segment 110 based on the selected hypothetical lane configuration 180. The control module 230 may determine the characteristics of the road segment 110 by assigning lane boundaries on the road segment 110 to correspond to the hypothetical lane boundaries in the hypothetical lane configuration 180. The control module 230 may determine the number of lanes in the road segment 110, the widths of the lanes in the road segment 110, the positions of the lane markings, the orientation of the lane markings, the positions of the lane boundaries (or edges), and/or the orientations of the lane boundaries (or edges) based on the hypothetical lane configuration 180.

In one or more arrangements, the control module 230 may re-constitute the road segments 110 with the identified lane boundaries into a single road. The control module 230 may update the characteristics data or any (internal or external) database with the characteristics of the road and/or road segment 110.

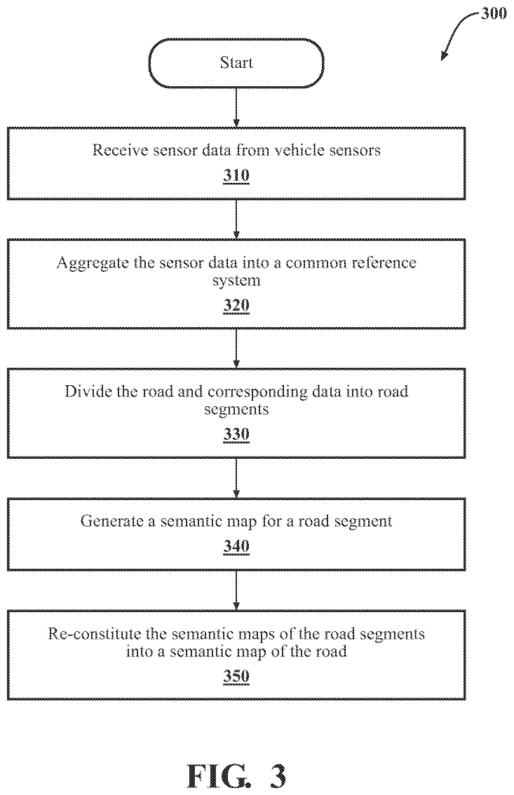

FIG. 3 is a flowchart illustrating one embodiment of a method 300 associated with generating a semantic map for a road. The method 300 will be described from the viewpoint of the semantic map generating system 100 of FIGS. 1-2. However, the method 300 may be adapted to be executed in any one of several different situations and not necessarily by the semantic map generating system 100 of FIGS. 1-2.

At step 310, the control module 230 may cause the processor(s) 210 to receive sensor data 242 from vehicle sensor(s). Additionally and/or alternatively, the control module 230 may receive sensor data 242 from other sensors, stationary sensors and/or mobile sensors. The sensor data 242 may include geographical coordinates indicating the trace points 112, 114, 116, 118, which refers to the positions of the vehicle 102, 104, 106, 108 and geographical coordinates indicating the key points 122, 132, 124, 134, 126, 136, 128, 138, which refers to the lane markings detected by the vehicle sensors.

At step 320, the control module 230 may cause the processor(s) 210 to aggregate the sensor data 242 into a common reference. As an example, the control module 230 may combine the sensor data 242 from various sources into a common reference system. In such a case, the control module 230 contains the sensor data 242 in a single frame and the points 112, 114, 116, 118, 122, 132, 124, 134, 126, 136, 128, 138 in the sensor data 242 are geographically positioned relative to the single frame.

At step 330, the control module 230 may cause the processor(s) 210 to divide the road and the corresponding sensor data 242 into multiple road segments 110 with corresponding sensor data 242. As previously explained, the control module 230 may divide the road into road segments 110 based on the curve of the road and the amount of sensor data within the road segments 110.

At step 340, the control module 230 may cause the processor(s) 210 to generate a semantic map for the road segment 110 as explained below in greater detail.

At step 350, the control module 230 may cause the processor(s) 210 to receive and combine the semantic maps for the road segments 110 into a semantic map for the road.

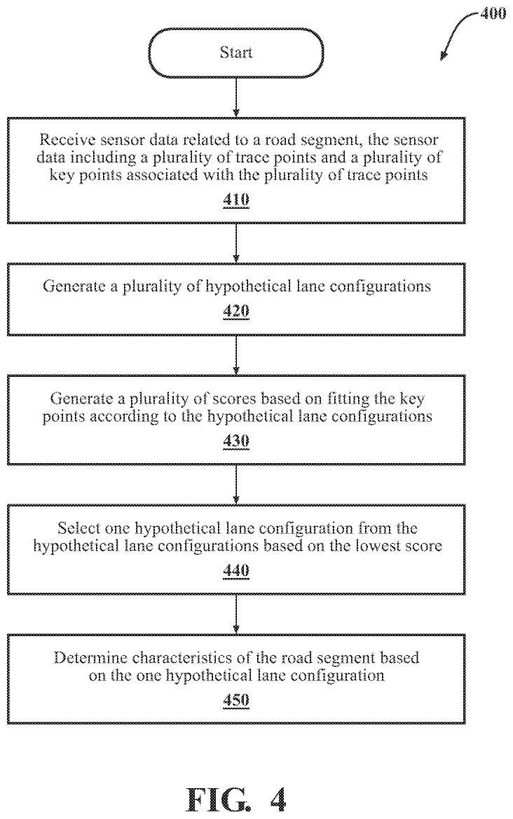

FIG. 4 is a flowchart illustrating one embodiment of a method 400 associated with generating a semantic map for a road segment 110. The method 400 will be described from the viewpoint of the semantic map generating system 100 of FIGS. 1-2. However, the method 400 may be adapted to be executed in any one of several different situations and not necessarily by the semantic map generating system 100 of FIGS. 1-2.

At step 410, the control module 230 may cause the processor(s) 210 to receive sensor data 242 related to the road segment 110. As previously mentioned, the sensor data 242 includes trace points 112, 114, 116, 118 and key points 122, 132, 124, 134, 126, 136, 128, 138 from sensors on multiple vehicles.

At step 420, the control module 230 may cause the processor(s) 210 to generate hypothetical lane configurations 150, 160, 180 based on potential characteristics of the road segment 110. The hypothetical lane configurations 150, 160, 180 include various lane number-lane width-lane orientation configurations. The control module 230 may determine the lane number-lane width-lane orientation configurations based on historical information, characteristics of an environment of the road segment 110, and/or characteristics of a neighboring road segment.

At step 430, the control module 230 may cause the processor(s) 210 to generate a plurality of scores based on how accurately the key points match the hypothetical lane configurations 150, 160, 180. As previously described, the control module 230 computes a score that expresses how well the key points match the hypothetical lane configurations 150, 160, 180. The key points include left key points (on one side of the vehicle) and right key points (on another side of the vehicle). The control module 230 fits a first curve to the left key points and a second curve to the right key points. The control module 230 determines a score based on the fit of the first curve to the left key points and the fit of the second curve the right key points. The control module 230 determines multiple scores based on how accurately the key points match the hypothetical lane configurations 150, 160, 180.

At step 440, the control module 230 may cause the processor(s) 210 to select one hypothetical lane configuration 180 from the hypothetical lane configurations 150, 160, 180 based on the best match, which results in the lowest score.

At step 450, the control module 230 may cause the processor(s) 210 to determine characteristics of the road segment 110 based on the hypothetical lane configuration 180. Based on the selected hypothetical lane configuration 180, the control module 230 may determine the number of lanes in the road segment 110, the width of the lanes in the road segment 110, positions and/or orientations of the lane markings on the road segment 110, and/or positions of boundaries of the road segment 110.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory storing machine-readable instructions that, when executed by the processor, cause the processor to:
receive sensor data related to a road segment, the sensor data including a plurality of trace points and a plurality of key points associated with the plurality of trace points, the plurality of trace points being related to positions of a vehicle in the road segment, the plurality of key points being related to lane boundaries;
generate a plurality of hypothetical lane configurations;
generate a plurality of scores based on how accurately the plurality of key points match the plurality of hypothetical lane configurations;
select one hypothetical lane configuration from the plurality of hypothetical lane configurations based on one score of the plurality of scores, the one score indicating most accurate match; and
determine characteristics of the road segment based on the one hypothetical lane configuration.

2. The system of claim 1, wherein the characteristics of the road segment include at least one of:
number of lanes in the road segment;
a width of one or more lanes in the road segment;
a position of one or more lane markings on the road segment; or
a position of one or more boundaries of the road segment.

3. The system of claim 1, wherein the machine-readable instructions further include instructions that when executed by the processor cause the processor to:
generate the plurality of scores based on a least squares method.

4. The system of claim 1, wherein the machine-readable instructions further include instructions that when executed by the processor cause the processor to:
divide a road into a plurality of road segments based on a curve of the road, wherein the plurality of road segments includes the road segment.

5. The system of claim 1, wherein the plurality of key points includes one or more key points, wherein one of the one or more key points is associated with a left lane boundary and an other of the one or more key points is associated with a right lane boundary.

6. The system of claim 1, wherein the machine-readable instructions further include instructions that when executed by the processor cause the processor to:
generate the plurality of hypothetical lane configurations based on historical information.

7. The system of claim 1, wherein the machine-readable instructions further include instructions that when executed by the processor cause the processor to:
generate the plurality of hypothetical lane configurations based on characteristics of an environment of the road segment.

8. The system of claim 1, wherein the machine-readable instructions further include instructions that when executed by the processor cause the processor to:
generate the plurality of hypothetical lane configurations based on characteristics of a neighboring road segment.

9. A method comprising:
receiving sensor data related to a road segment, the sensor data including a plurality of trace points and a plurality of key points associated with the plurality of trace points, the plurality of trace points being related to positions of a vehicle in the road segment, the plurality of key points being related to lane boundaries;
generating a plurality of hypothetical lane configurations;
generating a plurality of scores based on how accurately the plurality of key points match the plurality of hypothetical lane configurations;
selecting one hypothetical lane configuration from the plurality of hypothetical lane configurations based on one score of the plurality of scores, the one score indicating most accurate match; and
determining characteristics of the road segment based on the one hypothetical lane configuration.

10. The method of claim 9, wherein the characteristics of the road segment include at least one of:
number of lanes in the road segment;
a width of one or more lanes in the road segment;
a position of one or more lane markings on the road segment; or
a position of one or more boundaries of the road segment.

11. The method of claim 9, wherein the generating the plurality of scores is based on a least squares method.

12. The method of claim 9, further comprising:
dividing a road into a plurality of road segments based on a curve of the road, wherein the plurality of road segments includes the road segment.

13. The method of claim 9, wherein the plurality of key points includes one or more key points, wherein one of the one or more key points is associated with a left lane boundary and an other of the one or more key points is associated with a right lane boundary.

14. The method of claim 9, further comprising:
generating the plurality of hypothetical lane configurations based on historical information.

15. The method of claim 9, further comprising:
generating the plurality of hypothetical lane configurations based on characteristics of an environment of the road segment.

16. The method of claim 9, further comprising:
generating the plurality of hypothetical lane configurations based on characteristics of a neighboring road segment.

17. A non-transitory computer-readable medium including instructions that when executed by a processor cause the processor to:
receive sensor data related to a road segment, the sensor data including a plurality of trace points and a plurality of key points associated with the plurality of trace points, the plurality of trace points being related to positions of a vehicle in the road segment, the plurality of key points being related to lane boundaries;
generate a plurality of hypothetical lane configurations;
generate a plurality of scores based on how accurately the plurality of key points match the plurality of hypothetical lane configurations;
select one hypothetical lane configuration from the plurality of hypothetical lane configurations based on one score of the plurality of scores, the one score indicating most accurate match; and
determine characteristics of the road segment based on the one hypothetical lane configuration.

18. The non-transitory computer-readable medium of claim 17, wherein the characteristics of the road segment include at least one of:
number of lanes in the road segment;
a width of one or more lanes in the road segment;
a position of one or more lane markings on the road segment; or
a position of one or more boundaries of the road segment.

19. The non-transitory computer-readable medium of claim 17, wherein the instructions further include instructions that when executed by the processor cause the processor to:
generate the plurality of scores based on a least squares method.

20. The non-transitory computer-readable medium of claim 17, wherein the instructions further include instructions that when executed by the processor cause the processor to:
divide a road into a plurality of road segments based on a curve of the road, wherein the plurality of road segments including the road segment.
